(19) United States
(12) Patent Application Publication
(10) Pub. No.: US 2021/0156961 A1
(43) Pub. Date: May 27, 2021

(54) APPARATUS FOR AUTHENTICATING USER AND METHOD THEREOF

(71) Applicant: H LAB CO., LTD., Gyeongju-si (KR)

(72) Inventors: Hyoung Min KIM, Seoul (KR); Han June KIM, Seoul (KR); Jae Jun YOON, Gongju-si (KR); Hyo Ryun LEE, Pohang-si (KR); Jong Hee PARK, Seongnam-si (KR)

(73) Assignee: H LAB CO., LTD., Gyeongju-si (KR)

(21) Appl. No.: 16/707,510

(22) Filed: Dec. 9, 2019

(30) Foreign Application Priority Data
Nov. 26, 2019 (KR) 10-2019-0153384

(51) Int. Cl. G01S 7/41; G06K 9/00; G10L 17/00

(52) U.S. Cl. CPC G01S 7/415; G10L 17/005; G06K 9/00355

(57) ABSTRACT

Disclosed are an apparatus for authenticating a user in a user terminal and a method thereof. The method according to the present disclosure includes a step of providing a guide for inducing a user motion, a step of emitting a radar signal and generating a reference signal based on a reflected signal generated by a user motion, a step of generating a plurality of additional signals based on the characteristic values of the reference signal, and generating a plurality of additional samples self-duplicated by combining the additional signals with the reference signal, a step of outputting a guide for inducing a user motion for user authentication upon determining that user authentication is required, a step of recognizing a user motion based on the radar signal, and a step of performing user authentication based on the recognized user motion.

### CROSS-REFERENCE TO RELATED APPLICATION

This application claims priority to Korean Patent Application No. 10-2019-0153384, filed on Nov. 26, 2019 in the Korean Intellectual Property Office, the disclosure of which is incorporated herein by reference.

### BACKGROUND OF THE DISCLOSURE

### Field of the Disclosure

The present disclosure relates to an apparatus for authenticating a user and a method thereof.

### Description of the Related Art

User authentication can be classified into knowledge-based authentication, possession-based authentication, and biometric authentication.

Recently, behavior-based authentication has been spotlighted as an authentication method for overcoming inconvenience and security risk in biometric authentication.

For example, behavior-based authentication includes a method of extracting features of keyboard input, voice authentication, gait authentication, electrocardiogram authentication, and brain wave authentication.

In addition, to improve convenience in user authentication in the use environments of various electronic devices, research is being actively conducted.

### SUMMARY OF THE DISCLOSURE

Therefore, the present disclosure has been made in view of the above problems, and it is an object of the present disclosure to provide a service system that provides a variety of services through radar-based non-wearable gesture recognition technology.

It is another object of the present disclosure to provide novel User Interface/User Experience (UI/UX) and service through a use position-based gesture recognition service.

It is still another object of the present disclosure to provide a method of recognizing movement directions and gestures using reflected waves generated by interaction between user's motions and radar signals and an apparatus therefor.

It is still another object of the present disclosure to provide a method of recognizing various human motions by configuring a multi-radar emission frame by adjusting parameters of a plurality of radars or a single radar and providing a multi-radar field through the multi-radar emission frame and an apparatus therefor.

It is yet another object of the present disclosure to provide a method of generating user authentication data and performing user authentication based on user motions including gestures and an apparatus therefor.

In accordance with one aspect of the present disclosure, provided is a method of generating authentication data in a user terminal, the method including determining a user motion for input corresponding to a preset user authentication reliability rating; providing a guide for inducing the user motion for input; emitting a radar signal for recognizing the user motion for input and receiving a reflected signal generated by the user motion for input; generating a reference signal based on the reflected signal generated by the user motion for input; generating a plurality of additional signals based on characteristic values of the reference signal; generating a plurality of additional samples self-duplicated by combining the additional signals with the reference signal, and generating a user authentication database including the reference signal and the additional samples; and transmitting the user authentication database to an application or a server.

The user motion for input may include at least one of a single gesture, a gesture of drawing a symbol or a number, a single gesture and a voice consisting of two syllables, and a gesture of drawing a symbol or a number and a voice consisting of two or more syllables according to the user authentication reliability rating.

The receiving of the reflected signal may include transmitting a multi-radar emission frame that emits a first radar signal for detecting a position of an object and a second radar signal for gesture recognition in a time sharing manner when the preset user authentication reliability rating is at a highest level; and receiving a reflected signal of the first radar signal and a reflected signal of the second radar signal.

The generating of the reference signal may include extracting vector values for a movement direction of the object based on first signal processing for a reflected signal of a first radar signal received in an Nth (N being an integer greater than 0) period of the multi-radar emission frame and a reflected signal of a first radar signal received in an (N+k)th (k being an integer greater than 0) period of the multi-radar emission frame; and performing second signal processing for a reflected signal of a second radar signal received from an Nth period to an (N+k)th period of the multi-radar emission frame, and extracting characteristic values for the reflected signal of the second radar signal based on the second signal processing.

The characteristic values of the reference signal may include at least one of signal level information of a pre-processed reflected signal, phase information, pattern information of minute Doppler signals, and speed information.

In accordance with another aspect of the present disclosure, provided is a method authenticating a user in a user terminal, the method including providing a guide for inducing a user motion; emitting a radar signal and generating a reference signal based on a reflected signal generated by a user motion; generating a plurality of additional signals based on characteristic values of the reference signal, and generating a plurality of additional samples self-duplicated by combining the additional signals with the reference signal; outputting a guide for inducing a user motion for user authentication upon determining that user authentication is required; recognizing a user motion based on the radar signal; and performing user authentication based on the recognized user motion.

The guide for inducing a user motion may include a voice output or a display about a type of a user motion and the number of repetitions of the user motion.

The generating of the additional samples may include performing a convolution operation on the reference signal and the additional signals; performing a cross-correlation operation on samples generated through the convolution operation and the reference signal; and generating the additional samples based on results of the cross-correlation operation.

The outputting of the guide may include determining whether a user is in a preset user motion recognition area; and activating a radar for user motion recognition upon determining that the user is in the preset user motion recognition area.

The user motion may include a gesture and a voice, and the reference signal may include a first reference signal for the gesture, a second reference signal for the voice, and a third reference signal for a relationship between the first and second reference signals.

The performing of user authentication may include a low level authentication process of authenticating a user based on each of the gesture and the voice or a high level authentication process of authenticating a user based on a relationship between a radar signal generated by the gesture and a radar signal generated by the voice.

In accordance with still another aspect of the present disclosure, provided is a radar-based user authentication data generation apparatus including a user motion determiner for determining a user motion for input corresponding to a preset user authentication reliability rating; a guide provider for providing a guide for inducing the user motion for input; a radar for emitting a radar signal for recognizing the user motion for input; an antenna for receiving a reflected signal generated by the user motion for input; and a controller including at least one processor configured to generate a reference signal based on the reflected signal generated by the user motion for input, generate a plurality of additional signals based on characteristic values of the reference signal, generate a plurality of additional samples self-duplicated by combining the additional signals with the reference signal, generate a user authentication database including the reference signal and the additional samples, and transmit the user authentication database to an application or a server.

In accordance with yet another aspect of the present disclosure, provided is a radar-based user authentication apparatus including a guide provider for providing a guide for inducing a user motion; a radar for emitting a radar signal for recognizing the user motion; and a controller including at least one processor configured to generate a reference signal based on a reflected signal generated by the user motion, generate a plurality of additional signals based on characteristic values of the reference signal, generate a plurality of additional samples self-duplicated by combining the additional signals with the reference signal, control the guide provider to induce a user motion for user authentication upon determining that user authentication is required, recognize a user motion based on the radar signal, and perform user authentication based on the recognized user motion.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows a radar-based user authentication and human motion recognition service system according to one embodiment of the present disclosure;

FIG. 2 is a drawing for explaining various examples in which an apparatus for user authentication and gesture recognition is used;

FIG. 3 is a diagram for explaining the configuration of a radar-based human motion recognition apparatus according to one embodiment of the present disclosure;

FIG. 4 is a flowchart for explaining a method of providing a gesture recognition service according to one embodiment;

FIG. 5 is a diagram for explaining the control mode of an apparatus for providing a gesture recognition service according to one embodiment;

FIG. 6 is an exemplary view for explaining a gesture recognition area of an apparatus for providing a gesture recognition service according to one embodiment;

FIG. 7 is an exemplary view for explaining a position-based gesture recognition service according to one embodiment;

FIG. 8 is a flowchart for explaining a method for user motion-based user authentication and gesture recognition according to one embodiment;

FIG. 9 is a diagram for explaining the configuration of an apparatus for user authentication data generation and user authentication according to one embodiment;

FIG. 10 is a flowchart for explaining a user authentication method according to one embodiment; and

FIG. 11 is a flowchart for explaining a method of generating user authentication data according to one embodiment.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the disclosure and the appended claims, the singular form “a” or “an” is intended to include the plural forms as well, unless context clearly indicates otherwise.

In addition, terms such as “first” and “second” are used herein merely to describe a variety of constituent elements, but the constituent elements are not limited by the terms. The terms are used only for the purpose of distinguishing one constituent element from another constituent element.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In addition, in the following description of the present disclosure, a detailed description of known functions and configurations incorporated herein will be omitted when it may make the subject matter of the present disclosure unclear. The terms used in the specification are defined in consideration of functions used in the present disclosure, and can be changed according to the intent or conventionally used methods of clients, operators, and users. Accordingly, definitions of the terms should be understood on the basis of the entire description of the present specification.

According to one embodiment, user authentication data generation and user authentication may be performed through gesture recognition. In this specification, radar-based gesture recognition will be described, and then user authentication through radar-based user motion recognition will be described.

In addition, in this specification, a ‘user motion’ may include a ‘human motion’, a ‘gesture’, and a ‘user voice’. For example, the ‘user motion’ may include at least one of a user hand gesture and a user voice.

In addition, in this specification, human motion recognition includes gesture recognition and refers to recognizing various human movements, movement directions, and movement speeds. However, for convenience of description, gesture recognition may have the same meaning as human motion recognition.

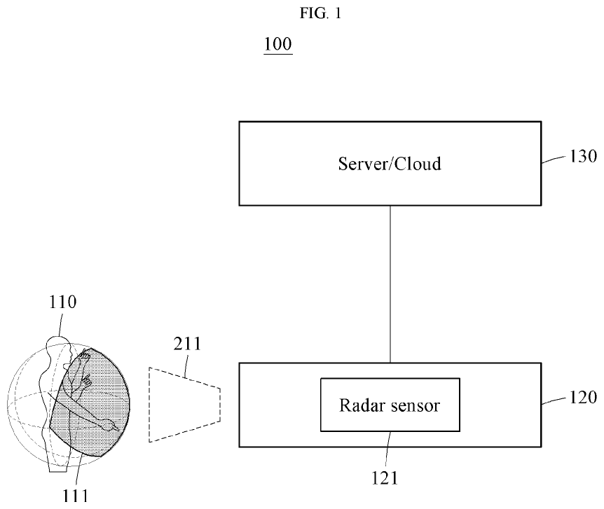

FIG. 1 shows a radar-based user authentication and human motion recognition service system according to one embodiment of the present disclosure.

Referring to FIG. 1, a radar-based human motion recognition service system includes an apparatus 120 for providing a gesture recognition service and a server/cloud 130.

The apparatus 120 for providing a gesture recognition service may recognize the gesture of a user 110 in a gesture recognition area 211 of a radar sensor 121.

In this case, the gesture recognition area 211 may be an area for detecting hand gestures or arm gestures of the user 110. That is, from the user's point of view, the gesture recognition area 211 may be recognized as a space 111 in which the user 110 moves their hands or arms.

The gesture recognition area 211 may be larger or smaller than the space 111 in which the user 110 moves their hands or arms. However, in this specification, for convenience of description, the gesture recognition area 211 and the space 111 in which the user 110 moves their hands or arms are regarded as the same concept.

The server/cloud 130 may be a cloud system connected to the apparatus 120 via a network, or a server system for providing services.

The apparatus 120 may transmit all data collected for gesture recognition to the server/cloud 130.

The server/cloud 130 may improve gesture recognition performance through machine learning based on data collected from the apparatus 120.

Learning processes for gesture recognition may include a process of transmitting radar sensor setup information for optimizing a radar sensor to the apparatus 120 and receiving a setup completion signal from the apparatus 120, a process of receiving data for learning from the apparatus 120, and a process of determining the parameters of a learning model.

In this case, optimization of a radar sensor may include adjusting data slice, adjusting the frame sequence of a chip signal, and adjusting a sampling rate for analog-to-digital conversion.

The process of determining the parameters of a learning model may include adjusting sampling data quantity and sampling data interval and adjusting an optimization algorithm.

In addition, the server/cloud 130 may receive a control signal from the apparatus 120 and transmit the control signal to another device that performs an operation according to the control signal.

In addition, the apparatus 120 for providing a gesture recognition service may include various types of devices equipped with a radar sensor. For example, the apparatus 120 may be a smartphone, television, computer, automobile, door phone, or game controller that provides gesture recognition-based UX/UI. In addition, the apparatus 120 may be configured to be connected to a smartphone via a connector such as USB.

The radar sensor 121 detects a gesture of a user in a preset radar recognition area.

The radar sensor 121 may be a sensor for radar-based motion recognition, such as an impulse-radio ultra-wideband (IR-UWB) radar sensor and a frequency modulated continuous wave (FMCW) radar sensor.

When the radar sensor 121 is applied, a precise motion such as a finger gesture may be recognized at a short range. In addition, compared to image-based motion recognition, privacy of individuals may be protected.

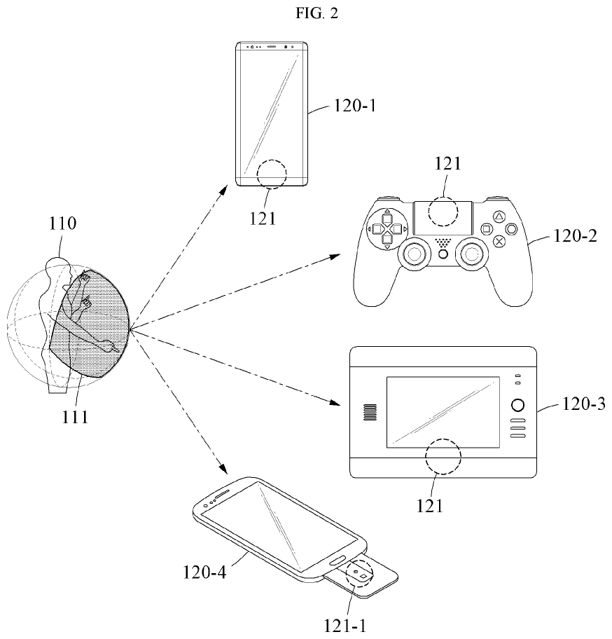

FIG. 2 is a drawing for explaining various examples in which an apparatus for user authentication and gesture recognition is used.

In this specification, the apparatus 120 equipped with the radar sensor 121 is referred to as an ‘echo device’, and an external device that receives a ‘control signal’ from the apparatus 120 equipped with the radar sensor 121 and performs an operation corresponding to a user gesture is referred to as an ‘external device’.

A ‘control signal’ means a command or data for performing an operation corresponding to a user gesture as a result of recognizing a gesture.

For example, when a user's finger gesture is recognized as a motion for executing a specific application, the ‘control signal’ may be an executive command for the specific application.

As another example, when a user's hand gesture corresponds to a preset password for releasing a door lock installed on a front door, the ‘control signal’ may be a command of ‘unlocking the door lock because a correct password has been input by the hand gesture’.

For example, a vehicle equipped with a radar sensor may be classified as an echo device. In addition, a home network system that receives a control signal from a smartphone equipped with a radar sensor through a network and performs an operation according to a recognized gesture may be referred to as an external device.

Referring to FIG. 2, a smartphone 120-1, a game controller 120-2, a door phone 120-3, and a device 121-1 capable of being connected to a smart apparatus 120-4 via a connector may be echo devices.

For example, a mobile terminal such as the smartphone 120-1 may be an echo device.

In this case, a process included in the apparatus 120 of FIG. 1 may determine any one of a home service area, a residential area, a public service area, a vehicle interior area, and a user-designated area based on position information of a mobile terminal, confirm a gesture recognition service provided in the determined area, and determine a control mode based on the confirmed gesture recognition service area.

In this case, the apparatus 120 of FIG. 1 may transmit the control signal to an execution unit of an external device that provides a gesture recognition service based on position information of a mobile terminal.

In the case of a control mode in an internal device, an echo device may be a device installed in any one of a home service area, a residential area, a public service area, a vehicle interior area, and a user-designated area, and the processor may generate the control signal according to a preset control mode when a user gesture is recognized.

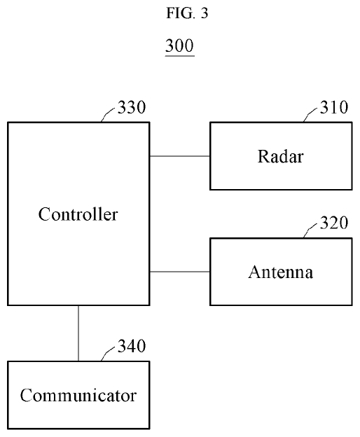

FIG. 3 is a diagram for explaining the configuration of a radar-based human motion recognition apparatus according to one embodiment of the present disclosure.

Referring to FIG. 3, a human motion recognition apparatus 300 may include radar 310, an antenna 320, and a controller 330. The human motion recognition apparatus 300 may further include a communicator 340.

The radar 310 emits a radar signal.

The antenna 320 receives a signal reflected from an object with respect to the emitted radar signal. In this case, the antenna 320 may be composed of a monopulse antenna, a phased array antenna, or an array antenna having a multichannel receiver structure.

The controller 330 may include at least one processor. In this case, the controller 330 may be connected to instructions or one or more computer-readable storage media recorded in a program.

Accordingly, the controller 330 may include at least one processor configured to set parameters for the radar 310 so that a first radar signal for detecting the position of an object is emitted in a first time interval, to detect the position of the object based on first signal processing for a reflected signal of the first radar signal, and to determine whether the position of the object is within a preset gesture recognition area.

In addition, when the position of the object is within a gesture recognition area, the controller 330 may be configured to adjust parameters for the radar 310 so that a second radar signal for gesture recognition is emitted in a second time interval, to determine situation information based on second signal processing for a reflected signal of the second radar signal, and to transmit the situation information to an application or a driving system.

In this case, the situation information may be determined by a running application.

For example, when a running application provides a user interface through gesture recognition, the situation information may be gesture recognition. In addition, when there is an activated sensor module, the situation information may be control information for the sensor module. In this case, the control information may be generated by gesture recognition, and may be a control signal corresponding to a recognized gesture.

The communicator 340 may transmit data to an external server or a device or receive data therefrom through a wired or wireless network.

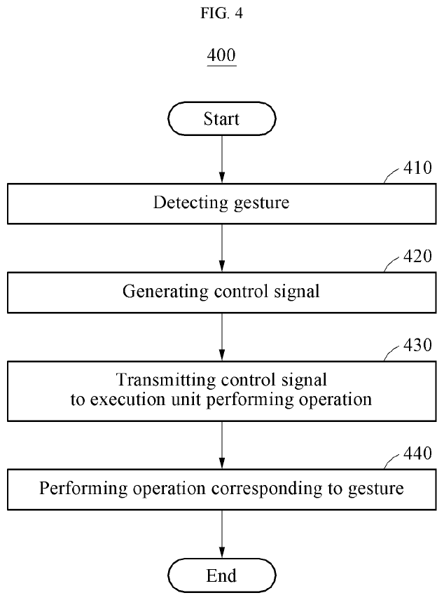

FIG. 4 is a flowchart for explaining a method of providing a gesture recognition service according to one embodiment.

The method shown in FIG. 4 may be performed using the apparatus 120 of FIG. 1 or an apparatus 300 of FIG. 3.

Accordingly, the method of providing a gesture recognition service according to one embodiment may be performed using an apparatus including at least one processor.

In Step 410, the apparatus detects a user gesture in a preset radar recognition area. In Step 420, the apparatus generates a control signal corresponding to the detected user gesture.

In this case, the apparatus may determine a control mode based on at least one of user interface setting information of a device equipped with the radar sensor, position information of the device, information about an application running on the device, and information about an external device connected to the device via a network, and may generate a control signal corresponding to the control mode.

In Step 430, the apparatus transmits the control signal to an execution unit that performs an operation corresponding to the user gesture.

When the control signal is about control of an echo device, in Step 440, the apparatus performs an operation corresponding to the gesture.

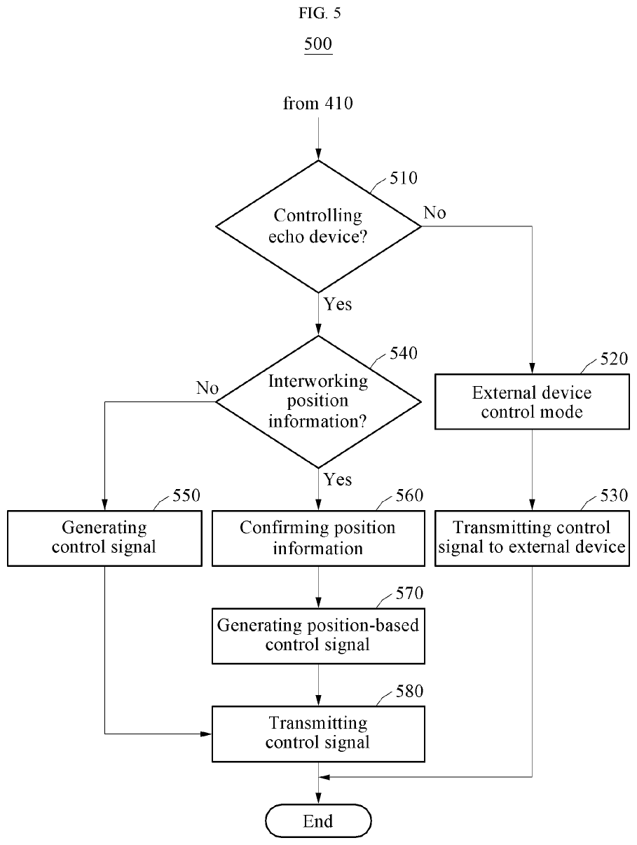

FIG. 5 is a diagram for explaining the control mode of an apparatus for providing a gesture recognition service according to one embodiment.

The method shown in FIG. 5 may be performed using the apparatus 120 of FIG. 1 or the apparatus 300 of FIG. 3.

Referring to FIG. 5, when a user gesture is detected, in Step 510, the apparatus confirms whether device setting is an echo device control mode.

In the echo device control mode, gesture recognition of the apparatus may be activated or a recognized gesture may be an operation for controlling an internal device.

In addition, when gesture recognition of the apparatus is activated, but when device setting is an external device control mode or a user gesture is an operation for controlling an external device, device setting may be an external device control mode.

In addition, when an external device is set to be controlled by an application running on an echo device, the apparatus may operate in a mode for controlling both an echo device and the external device.

For example, when an application running on an echo device is a temperature control application connected to a home network, a user gesture may relate to temperature control. In this case, the apparatus may control a communicator so that a control signal is transmitted to an external device via a network, and may include data for controlling temperature in the external device.

In addition, an echo device does not necessarily determine a control mode according to the flowchart shown in FIG. 5. That is, when the apparatus is not interlocked with an external device in the initial installation step, the flowchart shown in FIG. 5 may not be applied. For example, when a door phone is equipped with a radar sensor and is set to recognize only a gesture corresponding to a password, the flowchart shown in FIG. 5 is not applied.

When it is determined that device setting is not an echo device control mode in Step 510, in Step 520, the apparatus determines the device setting as an external device control mode and generates a control signal corresponding to a recognized gesture. Then, in Step 530, the apparatus transmits the control signal to an external device.

When it is determined that device setting is an echo device control mode in Step 510, in Step 540, the apparatus determines whether position information interworking is necessary.

When a user gesture is recognized as a motion that requires a position information interworking service or when a position information-based service is set to be activated in a device, position information interworking is required.

When position information interworking is not required, in Step 550, the apparatus generates a control signal corresponding to a user gesture and transmits the control signal to an execution unit.

When position information interworking is required, the apparatus confirms position information in Step 560, and generates a position-based control signal in Step 570.

In this case, the position-based control signal refers to a control signal that provides different services according to positions, places, and specific spaces.

For example, the same hand gesture may be recognized as different input commands depending on positions or places.

In Step 580, the apparatus transmits a control signal to the execution unit so that an operation corresponding to a user gesture is performed.

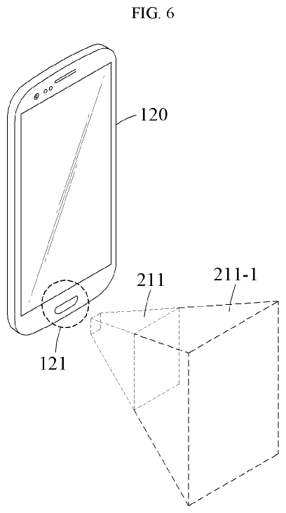

FIG. 6 is an exemplary view for explaining a gesture recognition area of an apparatus for providing a gesture recognition service according to one embodiment.

Referring to FIG. 6, a preset radar recognition area may be adjusted according to a control mode.

A processor 330 of FIG. 3 may set the recognition area as a proximity area 211 when an operation is performed in an echo device control mode.

In addition, when an operation is performed in an external device control mode and when simple control of a device is performed, the apparatus 120 may set the recognition area as an expanded proximity area 211-1.

For example, performing recognition for unlocking in a locked smartphone and performing a door opening function by recognizing driver's approach and gesture in a parked car may be examples of the simple control of a device.

Adjustment of a recognition area may be performed by adjusting the level of the output voltage of a radar sensor or by ignoring a gesture recognized in an area other than the recognition area.

In addition, according to the output of a radar sensor, the recognition area may be set wider than the expanded proximity area 211-1.

In this case, the apparatus 120 may operate in a control mode suitable for the proximity area 211, the expanded proximity area 211-1, or a long-range area.

In addition, the apparatus 120 may adjust a recognition area for a finger gesture, a hand gesture, or a body gesture by setting the radar sensor 121.

For example, to recognize a finger gesture, the proximity area 211 may be set as the recognition area, and to recognize a body gesture, a long-range area extended further than the expanded proximity area 211-1 or the expanded proximity area 211-1 may be set as the recognition area.

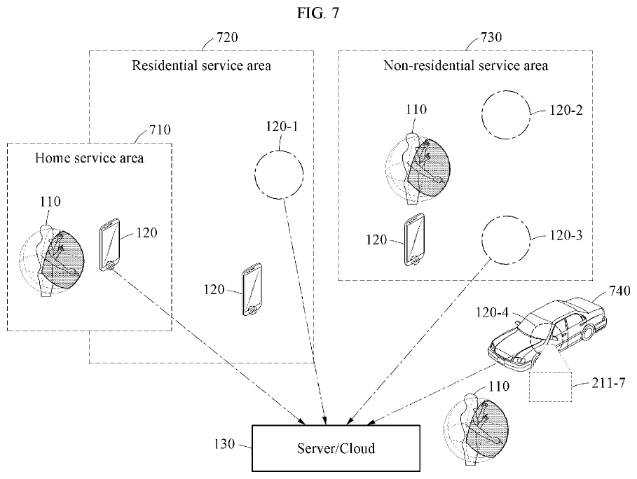

FIG. 7 is an exemplary view for explaining a position-based gesture recognition service according to one embodiment.

Referring to FIG. 7, the position-based gesture recognition service may include at least one of a home service area 710, a residential service area 720, and a non-residential service area 730.

Devices 120-1, 120-2, 120-3, and 120-4 installed in each area may each be an echo device equipped with a radar sensor. Accordingly, data collected from the devices 120-1, 120-2, 120-3, and 120-4 may be transmitted to the server/cloud 130.

In addition, a user gesture may be recognized through a mobile terminal 120 in each area, or may be directly recognized by the device 120-1, 120-2, 120-3, or 120-4 installed in each area.

For example, when the user 110 enters an area 740 in which a vehicle is parked, by deactivating gesture recognition of the mobile terminal 120 and recognizing a gesture in a gesture recognition area 211-7 of an echo device 120-4 installed in the vehicle, a control signal for door opening or starting may be generated, and an operation may be performed according to the control signal.

In addition, the position-based gesture recognition service may be provided in certain places such as theaters, fairgrounds, and exhibition halls.

In addition, the position-based gesture recognition service may be provided in the interior area of an automobile 740, and may provide a position-based service in consideration of location information according to movement of the automobile 740.

In this case, the position-based service includes generating a control signal for transmitting different commands depending on positions even when a user makes the same hand gesture. In this specification, user gestures and control signals for transmitting different commands according to positions may be expressed as ‘control languages’ defined as a sequence of actions.

For example, in a home service area, a continuous hand gesture of a user may be used as a means for controlling various devices installed in the home service area.

In addition, a device 120-1 installed in the residential service area 720 may be set to recognize a continuous hand gesture of a user to control an elevator, a service related to a parking lot, and the like.

In addition, a plurality of echo devices 120-2 and 120-3 may be installed in any one area. In this case, since recognition of a user motion is performed separately in the recognizable space of each echo device, in the separate space of each device, various gesture recognition services may be provided.

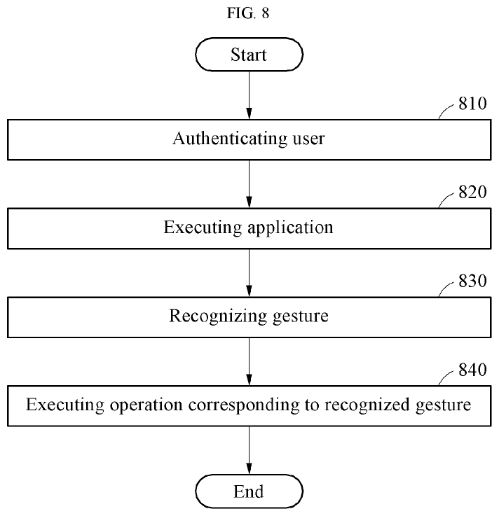

FIG. 8 is a flowchart for explaining a method for user motion-based user authentication and gesture recognition according to one embodiment.

User authentication data generation and user authentication according to one embodiment of the present disclosure may be performed before human motion recognition or gesture authentication described in FIGS. 1 to 7.

In addition, user authentication data generation and user authentication according to one embodiment may be used as a means for recognizing a user independently of human motion recognition or gesture authentication.

FIG. 8 shows an example of performing gesture recognition after performing user authentication in a device such as a smartphone.

Referring to FIG. 8, in Step 810, the device performs user authentication.

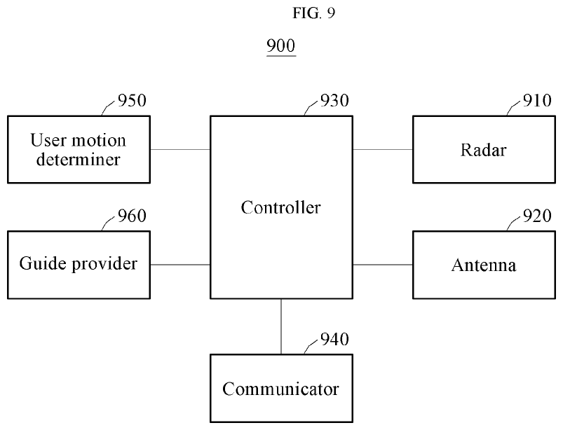

Authentication data generation for user authentication and a specific user authentication method will be described with reference to FIGS. 9 to 11.

In Step 820, the device may execute a required application after user authentication. For example, after user authentication, the device may output the home screen of a smartphone or execute a finance-related application.

In Step 830, the device may perform radar-based gesture recognition.

In Step 840, the device may execute an operation corresponding to the recognized gesture.

FIG. 9 is a diagram for explaining the configuration of an apparatus for user authentication data generation and user authentication according to one embodiment.

In this specification, an apparatus for user authentication data generation and user authentication is referred to simply as a user authentication apparatus.

Referring to FIG. 9, a user authentication apparatus 900 may include a radar 910, an antenna 820, a controller 930, a communicator 740, a user motion determiner 950, and a guide provider 860.

The user motion determiner 950 determines a user motion for input corresponding to a preset user authentication reliability rating.

In this case, the ‘user motion for input’ refers to a kind of gesture for authentication, such as a password. For example, the ‘user motion for input’ may include a gesture of moving the hand from left to right or from right to left, a gesture of drawing a circle, a gesture of drawing the letter “X”, a gesture of drawing the number 8, and a specific gesture taken with a voice consisting of three or more syllables.

In this specification, the ‘user motion for input’ may also be referred to as a ‘user motion’. In this case, the ‘user motion’ may include a ‘user motion for input’ for generating user authentication data and a ‘user motion’ for user authentication corresponding to a preset user motion for input.

The user authentication reliability rating means a level classified according to the security level of user authentication.

For example, according to the security level of user authentication, the ‘user motion for input’ may be classified as follows: dragging on a touch interface that has no security function, pattern input that is classified as a security function of a medium level, personal information number (PIN) input that is classified as a security function of a medium level, password input setting that is classified as a security function of a high level, and biometric recognition that is classified as a security function of a very high level.

Accordingly, user reliability ratings may be classified into none, low, medium, high, and very high.

The user reliability ratings may be determined according to user selection or security levels required by a device or an application.

For example, in the case of user authentication for identifying one of the family members, the user reliability rating may be ‘low’. In addition, the reliability rating of user authentication corresponding to a pattern input of a smartphone may be ‘medium’. In addition, in the case of user authentication required in a finance-related application, the user reliability rating may be ‘very high’.

By repeatedly performing machine learning on various user motions for input, an order of high reliability representing user's unique characteristics may be extracted.

For example, compared to a gesture of clenching and opening one's fist, a gesture of drawing the number 8 may have a higher level in reliability that represents user's unique characteristics.

In addition, compared to performing a single gesture, performing several gestures in succession may have a higher level in reliability that represents user's unique characteristics.

In Table 1, user motions for input corresponding to user authentication reliability ratings determined through machine learning are shown.

TABLE 1

| | User authentication reliability ratings | | | |
|---|---|---|---|---|
| | Low | Medium | High | Very high |
| User motions | A single gesture | Two or more gestures | A single gesture and a | Two or more gestures |
| | | in a row | voice (two syllables) | in a row and a voice |
| | | | | (five syllables or |
| | | | | more) |
| | Moving right hand | A gesture of drawing | A gesture of shaking | A gesture of drawing |
| | from right to left | the number 8 | one's palm and a | the number 8 and the |
| | A gesture of drawing | A gesture of drawing | voice consisting of | letter “X” |
| | a circle | the letter “X” | two or more syllables | A gesture of drawing |
| | | | A gesture of drawing | the number 8 and a |
| | | | a circle and a voice | voice consisting of |
| | | | consisting of two or | five or more syllables |
| | | | more syllables | |

As shown in Table 1, when the preset user authentication reliability rating is ‘medium’, the user motion determiner 950 may determine any one of ‘two or more gestures in a row’, a ‘gesture of drawing the number 8’, and a ‘gesture of drawing the letter “X”’ as the user motion for input.

The guide provider 860 provides user motions for input or guides for inducing user motions.

The guide for inducing a user motion may include a voice output or a display about a type of a user motion and the number of repetitions of the user motion.

The user motion includes a single gesture, a gesture of drawing a symbol or a number, a single gesture and a voice consisting of two syllables, and a gesture of drawing a symbol or a number and a voice consisting of two or more syllables.

For example, providing a guide on the type of user motion may be a voice guidance for inducing a user to perform a desired motion or a voice guidance for inducing a user motion corresponding to a preset user authentication reliability rating.

The number of repetitions of a user motion is for obtaining a plurality of raw data. For example, the number of repetitions of a user motion may be determined to be 3 to 15 times.

In this case, the number of repetitions of a user motion may be determined according to a user authentication reliability rating and the complexity of a user motion. For example, when the user authentication reliability rating is high, a large number of repetitions may be required. On the contrary, when the user authentication reliability rating is low, a small number of repetitions may be required.

The radar 910 emits radar signals for recognizing user motions.

The radar 910 may include the radar sensor 121 shown in FIG. 1, and may perform the same function as the radar 310 shown in FIG. 3.

In addition, the radar 910 may be configured as a radar array including a plurality of radars. The radars may operate in the same frequency band or in different frequency bands.

The first radar among the radars may emit a first radar signal for detecting a position of an object or a first situation.

The second radar among the radars may emit a second radar signal for detecting gesture recognition or a second situation.

In this case, the first situation indicates that existence of an object, approach of a user, movement of an object, or movement of a user has occurred. The second situation may be a situation recognized according to applications or operation modes being executed, such as gesture recognition and control of connected sensors.

The first radar signal may be a pulse radar signal using a pulse signal, and the second radar signal may be a continuous wave radar signal continuously output with respect to time.

At least one of the radars may be used to obtain voice data of a user. Accordingly, at least one of the radars may be set to face the lungs, vocal cords, and articulators of a user, and may be used to obtain vibration signals generated by the lungs, vocal cords, and articulators of the user during speech.

The antenna 820 may perform the same function as the antenna 320 of FIG. 3.

The antenna 820 receives a reflected signal generated by a user motion.

In addition, the antenna 820 may receive a reflected signal generated by the movements of the lungs, vocal cords, and articulators of a user during speech.

The controller 930 may perform the same function as the controller 330 of FIG. 3.

In addition, the controller 930 may include at least one processor configured to generate a reference signal based on a reflected signal generated by a user motion, generate a plurality of additional signals based on the characteristic values of the reference signal, generate a plurality of additional samples self-duplicated by combining the additional signals with the reference signal, generate a user authentication database including the reference signal and the additional samples, and transmit the user authentication database to an application or a server.

In addition, the controller 930 may be configured to generate a reference signal based on a reflected signal generated by a user motion, generate a plurality of additional signals based on the characteristic values of the reference signal, generate a plurality of additional samples self-duplicated by combining the additional signals with the reference signal, control the guide provider to induce a user motion for user authentication upon determining that user authentication is required, recognize a user motion based on the radar signal, and perform user authentication based on the recognized user motion.

In this case, the controller 930 may determine whether a user is in a preset user motion recognition area, and may activate the radar for user motion recognition upon determining that the user is in the preset user motion recognition area.

In this case, the characteristic values of a reference signal may include signal level information of a pre-processed reflected signal, phase information, and pattern information of minute Doppler signals, and speed information.

In this case, the user motion may include a gesture and a voice, and the reference signal may include a first reference signal for the gesture, a second reference signal for the voice, and a third reference signal generated by combining the first and second reference signals.

The controller 930 may perform a convolution operation on the reference signal and the additional signals, perform a cross-correlation operation on samples generated through the convolution operation and the reference signal, and generate the additional samples based on the results of the cross-correlation operation.

The controller 930 may perform a low level authentication process of authenticating a user based on each of a gesture and a voice or a high level authentication process of authenticating a user based on a relationship between a radar signal generated by the gesture and a radar signal generated by the voice.

The communicator 740 may perform the same function as the communicator 340 of FIG. 3.

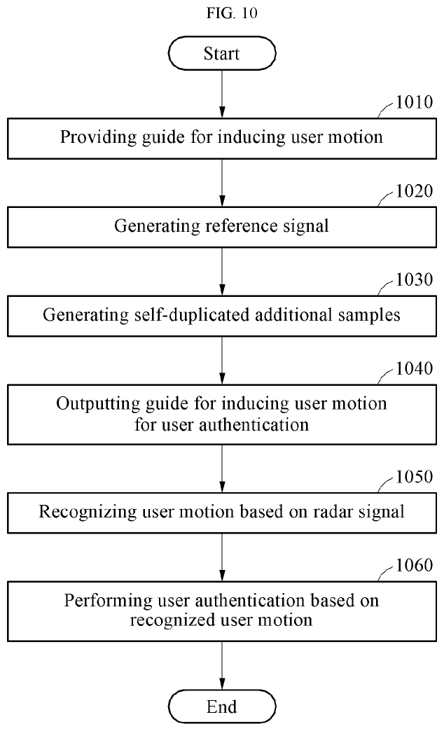

FIG. 10 is a flowchart for explaining a user authentication method according to one embodiment.

The method shown in FIG. 10 may be performed using the apparatus shown in FIG. 9.

In Step 1010, the apparatus provides a guide for inducing a user motion.

In Step 1020, the apparatus emits a radar signal, and generates a reference signal based on a reflected signal generated by a user motion.

In Step 1020, the apparatus may obtain raw data for each of user motions repeated 3 to 15 times, and may obtain refined data by preprocessing the obtained raw data.

In this case, preprocessing of raw data may include noise removal, normalization, digital signal conversion, range-processing to extract distance information from a reflected signal through a window function and fast Fourier transform, and echo suppression processing to suppress a signal magnitude of clutter having a relatively high reflectance.

In Step 1020, the apparatus may extract reference information or characteristic values that may specify or represent a user using a plurality of refined data.

For example, representative reference information may include information about the pattern, magnitude, phase, and velocity of a signal waveform representing user characteristics.

In Step 1020, the apparatus may determine, as a reference signal, refined data that best reflect reference information or characteristic values among a plurality of refined data, or may select any one of a plurality of refined data and reflect a preset weight value to reference information or characteristic values to generate a reference signal.

In Step 1020, the apparatus may obtain a difference value of information between a determined reference signal and raw data. For example, the difference value of information between a reference signal and raw data may include min-max variation, phase shift offset, frequency offset, and radial velocity variation.

In Step 1020, the apparatus may extract deviation value information with respect to information included in a reference signal. In this case, deviation value information may be used to generate a plurality of additional samples that are self-duplicated.

In addition, the apparatus may be provided with a microphone capable of inputting voices, and the apparatus may obtain a voice signal through a microphone or a radar.

For example, first user authentication data may be generated based on the pattern, signal magnitude, and the like of a voice signal obtained through a microphone. In addition, second user authentication data may be generated based on a reflected signal for movements of the articulators, and the like of a user using a radar. In addition, the apparatus may generate third user authentication data through radar-based gesture recognition.

In Step 1030, the apparatus generates a plurality of additional signals based on the characteristic values of a reference signal, and generates a plurality of additional samples self-duplicated by combining the additional signals with the reference signal.

In Step 1030, the apparatus may generate a plurality of additional signals based on deviation value information.

For example, when phase shift resolution has deviation value information from 0 to 5 in a unit of 1 degree and frequency offset has deviation value information from −5 to 5 in a unit of 0.1 degree, 500 additional signals may be generated within a range that satisfies the two information.

The additional signals may be generated in the form of ripple or noise that is capable of being combined with a reference signal.

In this case, since the additional signals are obtained from raw data for a specific user, different numbers of the signals may be generated for each individual, and each individual may have a characteristic value.

In Step 1030, the apparatus may generate samples by performing a convolution operation on each of a plurality of additional signals and a reference signal.

By combing a plurality of additional signals and a reference signal, a plurality of self-duplicated additional samples that are not obtained directly from a user may be generated.

Since the result of a convolution operation is a form of combining rather than a form in which signal information is accurately added, signal information generated by combining may change according to the form or information of a reference signal.

Accordingly, the apparatus may perform a cross-correlation operation on additional samples and a reference signal, and based on the result of the cross-correlation operation, may determine, as additional samples for user authentication, only samples that do not differ significantly from the reference signal or raw data.

In Step 1040, upon determining that user authentication is required, the apparatus outputs a guide for inducing a user motion for user authentication.

Examples of when user authentication is required may include when a user unlocks a device, when a user enters home through a front door, and when one of the limited number of people needs to be identified.

For example, the guide for inducing a user motion for user authentication may include one or two voice prompts or a display for the user motion input in Step 1010.

In an embodiment, the apparatus may perform proximity-based verification of a user or a user terminal, and then perform user motion-based user authentication.

Accordingly, in Step 1040, the apparatus may determine whether a user is in a preset user motion recognition area, and may activate the radar for user motion recognition upon determining that the user is in the preset user motion recognition area.

To confirm the proximity of a user terminal, an apparatus 900 shown in FIG. 9 may include network interface controller (NIC) communication modules such as Bluetooth and Wi-Fi.

For example, a user terminal may activate Wi-Fi, generate a probe message, and broadcast the probe message including preamble information including a MAC address or preset information.

The apparatus 900 may detect access of a user terminal using a pre-stored MAC address or preset information of the user terminal.

Accordingly, the apparatus 900 may perform primary user authentication before user motion authentication by detecting access of a pre-registered user terminal, and then may perform secondary user authentication based on a user motion.

In Step 1050, the apparatus recognizes a user motion based on a radar signal.

In this case, when a user motion includes a voice, the apparatus may perform user authentication by comparing a gesture with self-duplicated additional samples, and then may perform user authentication by comparing the voice data with the self-duplicated additional samples.

In addition, when a gesture and a voice are input at the same time, user authentication may be performed using samples generated by combing samples for the gesture and samples for the voice.

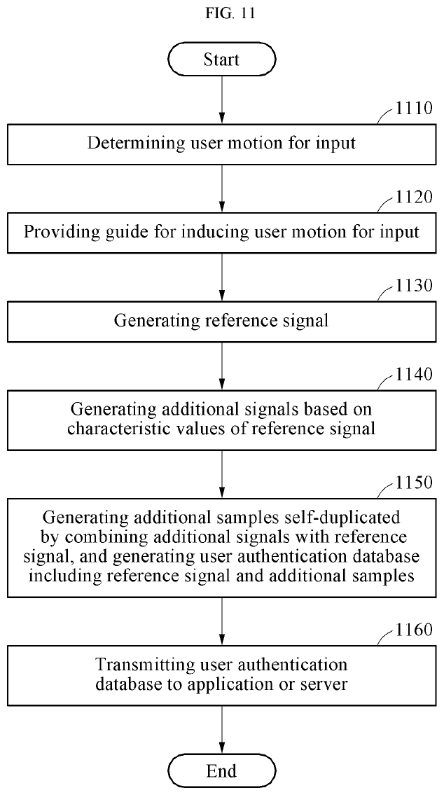

FIG. 11 is a flowchart for explaining a method of generating user authentication data according to one embodiment.

The method shown in FIG. 11 may be performed using the apparatus 900 shown in FIG. 9.

In Step 1110, the apparatus determines a user motion for input corresponding to a preset user authentication reliability rating.

In Step 1120, the apparatus provides a guide for inducing a user motion for input.

In Step 1130, the apparatus emits a radar signal for recognizing a user motion for input, receives a reflected signal generated by the user motion for input, and generates a reference signal based on the reflected signal by the user motion for input.

In Step 1140, the apparatus generates a plurality of additional signals based on the characteristic values of the reference signal.

In Step 1150, the apparatus generates a plurality of additional samples self-duplicated by combing the additional signals with the reference signal, and generates a user authentication database including the reference signal and the additional samples.

In Step 1160, the apparatus transmits the user authentication database to an application or a server.

The application or the server may perform user authentication by matching the reference signal and the additional samples stored in the user authentication database with a signal input upon user authentication.

According to the present disclosure, a variety of services can be provided through radar-based non-wearable gesture recognition technology.

In addition, novel User Interface/User Experience (UI/UX) and service can be provided through a use position-based gesture recognition service.

In addition, by configuring a multi-radar emission frame by adjusting parameters of a plurality of radars or a single radar and providing a multi-radar field through the multi-radar emission frame, various human motions can be recognized.

In addition, a method of generating user authentication data and performing user authentication based on user behaviors including gestures and an apparatus therefor are provided.

The apparatus described above may be implemented as a hardware component, a software component, and/or a combination of hardware components and software components. For example, the apparatus and components described in the embodiments may be achieved using one or more general purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications executing on the operating system. In addition, the processing device may access, store, manipulate, process, and generate data in response to execution of the software. For ease of understanding, the processing apparatus may be described as being used singly, but those skilled in the art will recognize that the processing apparatus may include a plurality of processing elements and/or a plurality of types of processing elements. For example, the processing apparatus may include a plurality of processors or one processor and one controller. Other processing configurations, such as a parallel processor, are also possible.

The software may include computer programs, code, instructions, or a combination of one or more of the foregoing, configure the processing apparatus to operate as desired, or command the processing apparatus, either independently or collectively. In order to be interpreted by a processing device or to provide instructions or data to a processing device, the software and/or data may be embodied permanently or temporarily in any type of a machine, a component, a physical device, a virtual device, a computer storage medium or device, or a transmission signal wave. The software may be distributed over a networked computer system and stored or executed in a distributed manner. The software and data may be stored in one or more computer-readable recording media.

The methods according to the embodiments of the present disclosure may be implemented in the form of a program command that can be executed through various computer means and recorded in a computer-readable medium. The computer-readable medium can store program commands, data files, data structures or combinations thereof. The program commands recorded in the medium may be specially designed and configured for the present disclosure or be known to those skilled in the field of computer software. Examples of a computer-readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include machine language code created by a compiler and high-level language code executable by a computer using an interpreter and the like. The hardware devices described above may be configured to operate as one or more software modules to perform the operations of the embodiments, and vice versa.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

What is claimed is:

1. A method of generating authentication data in a user terminal, the method comprising:
determining a user motion for input corresponding to a preset user authentication reliability rating;
providing a guide for inducing the user motion for input;
emitting a radar signal for recognizing the user motion for input and receiving a reflected signal generated by the user motion for input;
generating a reference signal based on the reflected signal generated by the user motion for input;
generating a plurality of additional signals based on characteristic values of the reference signal;
generating a plurality of additional samples self-duplicated by combining the additional signals with the reference signal, and generating a user authentication database comprising the reference signal and the additional samples; and
transmitting the user authentication database to an application or a server.

2. The method according to claim 1, wherein the user motion for input comprises at least one of a single gesture, a gesture of drawing a symbol or a number, a single gesture and a voice consisting of two syllables, and a gesture of drawing a symbol or a number and a voice consisting of two or more syllables according to the user authentication reliability rating.

3. The method according to claim 2, wherein the receiving of the reflected signal comprises transmitting a multi-radar emission frame that emits a first radar signal for detecting a position of an object and a second radar signal for gesture recognition in a time sharing manner when the preset user authentication reliability rating is at a highest level; and
receiving a reflected signal of the first radar signal and a reflected signal of the second radar signal.

4. The method according to claim 3, wherein the generating of the reference signal comprises extracting vector values for a movement direction of the object based on first signal processing for a reflected signal of a first radar signal received in an Nth (N being an integer greater than 0) period of the multi-radar emission frame and a reflected signal of a first radar signal received in an (N+k)th (k being an integer greater than 0) period of the multi-radar emission frame; and
performing second signal processing for a reflected signal of a second radar signal received from an Nth period to an (N+k)th period of the multi-radar emission frame, and extracting characteristic values for the reflected signal of the second radar signal based on the second signal processing.

5. The method according to claim 1, wherein the characteristic values of the reference signal comprise at least one of signal level information of a pre-processed reflected signal, phase information, pattern information of minute Doppler signals, and speed information.

6. A method of authenticating a user in a user terminal, the method comprising:
providing a guide for inducing a user motion;
emitting a radar signal and generating a reference signal based on a reflected signal generated by a user motion;
generating a plurality of additional signals based on characteristic values of the reference signal, and generating a plurality of additional samples self-duplicated by combining the additional signals with the reference signal;
outputting a guide for inducing a user motion for user authentication upon determining that user authentication is required;
recognizing a user motion based on the radar signal; and
performing user authentication based on the recognized user motion.

7. The method according to claim 6, wherein the guide for inducing a user motion comprises a voice output or a display about a type of a user motion and the number of repetitions of the user motion.

8. The method according to claim 7, wherein the user motion comprises at least one of a single gesture, a gesture of drawing a symbol or a number, a single gesture and a voice consisting of two syllables, and a gesture of drawing a symbol or a number and a voice consisting of two or more syllables.

9. The method according to claim 6, wherein the characteristic values of the reference signal comprise at least one of signal level information of a pre-processed reflected signal, phase information, pattern information of minute Doppler signals, and speed information.

10. The method according to claim 6, wherein the generating of the additional samples comprises performing a convolution operation on the reference signal and the additional signals;
performing a cross-correlation operation on samples generated through the convolution operation and the reference signal; and
generating the additional samples based on results of the cross-correlation operation.

11. The method according to claim 6, wherein the outputting of the guide comprises determining whether a user is in a preset user motion recognition area; and
activating a radar for user motion recognition upon determining that the user is in the preset user motion recognition area.

12. The method according to claim 6, wherein the user motion comprises a gesture and a voice, and the reference signal comprises a first reference signal for the gesture, a second reference signal for the voice, and a third reference signal for a relationship between the first and second reference signals.

13. The method according to claim 12, wherein the performing of user authentication comprises a low level authentication process of authenticating a user based on each of the gesture and the voice or a high level authentication process of authenticating a user based on a relationship between a radar signal generated by the gesture and a radar signal generated by the voice.

14. A radar-based user authentication data generation apparatus, comprising:
a user motion determiner for determining a user motion for input corresponding to a preset user authentication reliability rating;
a guide provider for providing a guide for inducing the user motion for input;
a radar for emitting a radar signal for recognizing the user motion for input;
an antenna for receiving a reflected signal generated by the user motion for input; and
a controller comprising at least one processor configured to generate a reference signal based on the reflected signal generated by the user motion for input, generate a plurality of additional signals based on characteristic values of the reference signal, generate a plurality of additional samples self-duplicated by combining the additional signals with the reference signal, generate a user authentication database comprising the reference signal and the additional samples, and transmit the user authentication database to an application or a server.

15. A radar-based user authentication apparatus, comprising:
a guide provider for providing a guide for inducing a user motion;
a radar for emitting a radar signal for recognizing the user motion; and
a controller comprising at least one processor configured to generate a reference signal based on a reflected signal generated by the user motion, generate a plurality of additional signals based on characteristic values of the reference signal, generate a plurality of additional samples self-duplicated by combining the additional signals with the reference signal, control the guide provider to induce a user motion for user authentication upon determining that user authentication is required, recognize a user motion based on the radar signal, and perform user authentication based on the recognized user motion.

16. The radar-based user authentication apparatus according to claim 15, wherein the guide for inducing a user motion comprises a voice output or a display about a type of a user motion and the number of repetitions of the user motion.

17. The radar-based user authentication apparatus according to claim 16, wherein the user motion comprises at least one of a single gesture, a gesture of drawing a symbol or a number, a single gesture and a voice consisting of two syllables, and a gesture of drawing a symbol or a number and a voice consisting of two or more syllables.

18. The radar-based user authentication apparatus according to claim 15, wherein the characteristic values of the reference signal comprise at least one of signal level information of a pre-processed reflected signal, phase information, pattern information of minute Doppler signals, and speed information.

19. The radar-based user authentication apparatus according to claim 15, wherein the controller performs a convolution operation on the reference signal and the additional signals, performs a cross-correlation operation on samples generated through the convolution operation and the reference signal, and generates the additional samples based on results of the cross-correlation operation.

20. The radar-based user authentication apparatus according to claim 15, wherein the controller determines whether a user is in a preset user motion recognition area, and activates the radar for user motion recognition upon determining that the user is in the preset user motion recognition area.

21. The radar-based user authentication apparatus according to claim 15, wherein the user motion comprises a gesture and a voice, and the reference signal comprises a first reference signal for the gesture, a second reference signal for the voice, and a third reference signal for a relationship between the first and second reference signals.

22. The radar-based user authentication apparatus according to claim 21, wherein the controller performs a low level authentication process of authenticating a user based on each of the gesture and the voice or a high level authentication process of authenticating a user based on a relationship between a radar signal generated by the gesture and a radar signal generated by the voice.
